(19) United States
(12) Patent Application Publication
(10) Pub. No.: US 2025/0390789 A1
(43) Pub. Date: Dec. 25, 2025

(54) VALIDATION CONTROLLED BACK PROPAGATION FOR MODEL TRAINING

(71) Applicant: International Business Machines Corporation, Armonk, NY (US)

(72) Inventors: James Liam Finnie, BOEBLINGEN (DE); Calisto Zuzarte, Markham (CA)

(21) Appl. No.: 18/752,847

(22) Filed: Jun. 25, 2024

(51) Int. Cl. G06N 20/00

(52) U.S. Cl. CPC G06N 20/00

(57) ABSTRACT

An example operation may include one or more of storing a validation function and a training set comprising a plurality of training samples, executing a machine learning (ML) model on the plurality of training samples using a software application during an epoch of a multi-epoch training process performed by the software application, wherein the executing includes retrieving a training sample from the training set, executing the ML model on the training sample to generate a model prediction for the training sample, determining an accuracy of the ML model for the training sample based on the model prediction, an expected output, and the validation function, skipping a back propagation process of the ML model for the training sample based on the accuracy exceeding a pre-determined threshold value, and retrieving a next training sample from the training set based on the skipping.

### BACKGROUND

Machine learning (ML) models and artificial intelligence (AI) models can be trained to provide predictions across a range of input values. However, training time, computing model losses, and resource usage may be prohibitive.

### SUMMARY

One example embodiment provides a computer-implemented method that includes one or more of storing a validation function and a training set comprising a plurality of training samples, executing a machine learning (ML) model on the plurality of training samples using a software application during an epoch of a multi-epoch training process performed by the software application, wherein the executing comprises retrieving a training sample from the training set, executing the ML model on the training sample to generate a model prediction for the training sample, determining an accuracy of the ML model for the training sample based on the model prediction, an expected output, and the validation function, skipping a back propagation process of the ML model for the training sample based on the accuracy exceeding a pre-determined threshold value, and retrieving a next training sample from the training set based on the skipping.

Another example embodiment provides a computer system that may include a processor set, a set of one or more computer-readable storage media, and program instructions, stored in the set of one or more storage media, that cause the processor set to perform computer operations to one or more of store a validation function and a training set comprising a plurality of training samples, execute a machine learning (ML) model on the plurality of training samples using a software application during an epoch of a multi-epoch training process performed by the software application, wherein, during the execution of the epoch, the processor set is configured to retrieve a training sample from the training set, execute the ML model on the training sample to generate a model prediction for the training sample, determine an accuracy of the ML model for the training sample based on the model prediction, an expected output, and the validation function, skip a back propagation process of the ML model for the training sample based on the accuracy exceeding a pre-determined threshold value, and retrieve a next training sample from the training set based on the skipping.

A further example embodiment provides a computer program product that may include a set of one or more computer-readable storage media, and program instructions, stored in the set of one or more computer-readable storage media, for causing a processor set to perform computer operations including one or more of storing a validation function and a training set comprising a plurality of training samples, executing a machine learning (ML) model on the plurality of training samples using a software application during an epoch of a multi-epoch training process performed by the software application, wherein the executing comprises retrieving a training sample from the training set, executing the ML model on the training sample to generate a model prediction for the training sample, determining an accuracy of the ML model for the training sample based on the model prediction, an expected output, and the validation function, skipping a back propagation process of the ML model for the training sample based on the accuracy exceeding a pre-determined threshold value, and retrieving a next training sample from the training set based on the skipping.

### BRIEF DESCRIPTION OF THE DRAWINGS

FIG. 1 is a diagram illustrating a computing environment according to an embodiment of the instant solution.

FIG. 2A is a system diagram illustrating integration of an AI model into any decision point according to the examples and features of the instant solution.

FIG. 2B is a diagram illustrating a process for developing an AI model that supports AI-assisted computer decision points according to the examples and features of the instant solution.

FIG. 2C is a diagram illustrating a process for utilizing an AI model that supports AI-assisted computer decision points according to examples and features of the instant solution.

FIG. 3A is a diagram illustrating a multi-epoch training process according to examples and features of the instant solution.

FIG. 3B is a diagram illustrating the multi-epoch training process and details of a first sub-loop of the process according to examples and features of the instant solution.

FIG. 3C is a diagram illustrating the multi-epoch training process and details of a second sub-loop of the process according to examples and features of the instant solution.

FIG. 4A is a diagram illustrating a process of skipping a back propagation process during an epoch of training a model according to examples of the features of the instant solution.

FIG. 4B is a diagram illustrating a process of presenting a notification of the skipped back propagation process via a GUI according to examples of the features of the instant solution.

FIG. 4C is a diagram illustrating a process of skipping an execution of the ML model on a training sample according to examples of the features of the instant solution.

FIG. 5A illustrates a flow diagram, according to example embodiments.

FIG. 5B illustrates a flow diagram, according to example embodiments.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

According to an aspect of the example embodiments, there is provided a computer system that includes a processor set, a set of one or more computer-readable storage media, and program instructions, stored in the set of one or more storage media, for causing the processor set to perform operations to store a validation function and a training set comprising a plurality of training samples, execute a machine learning (ML) model on the plurality of training samples using a software application during an epoch of a multi-epoch training process performed by the software application, wherein, during the execution of the epoch, the processor set is configured to retrieve a training sample from the training set, execute the ML model on the training sample to generate a model prediction for the training sample, determine an accuracy of the ML model for the training sample based on the model prediction, an expected output, and the validation function, skip a back propagation process of the ML model for the training sample based on the accuracy exceeding a pre-determined threshold value, and retrieve a next training sample from the training set based on the skipping. The apparatus has the technical effect of reducing the processing time and cost for training a ML model on samples for which the model is already well-trained (e.g., accurate). A technical advantage of the apparatus is that the overall model training time can be reduced and bandwidth on the training platform can be conserved in comparison to a traditional model training process in which back propagation is always performed, e.g., for each training sample.

In embodiments, the processor set is configured to skip execution of a loss function on the model prediction of the training sample to compute a loss for the ML model and skip a process of updating weights of the ML model based on the loss. The technical advantage of this feature is that the loss function does not need to be executed and the calculated loss does not need to be propagated back through the ML model thereby conserving significant execution cost and time.

In some embodiments, the processor set is configured to execute the ML model on a validation set during a previous epoch of the multi-epoch training process to determine the validation function. A technical advantage of this feature is that model-specific performance data is generated to produce a benchmark for controlling future training of the model, thereby improving the efficiency of the machine learning training process.

In some embodiments, the processor set is further configured to execute the ML model on the next training sample to generate a next model prediction for the next training sample, determine an additional accuracy of the ML model based on the next model prediction, an expected model output of the next model prediction, and the validation function, and execute the back propagation process of the ML model for the next training sample based on the additional accuracy not exceeding the pre-determined threshold value. A technical advantage of this feature is a further reduction in machine learning training time and required computational resources by selectively/dynamically identifying and skipping less valuable training segments.

In some embodiments, the processor set is configured to determine the next training sample is a last training sample in the training set, and in response, execute the ML model on a plurality of validation samples in a validation set to generate additional model predictions for the plurality of validation samples, determine a mean validation error of the ML model based on the additional model predictions and expected outputs of the plurality of validation samples, and update the validation function using the determined mean validation error. The technical effect of this feature is that the mean validation error can be determined using the same validation function used to validate an individual training sample after feed forwarding the training sample through the ML model. Another technical effect of this feature is that the mean validation error can be used to update the validation function such that back propagation processing can be skipped for subsequent training samples whose determined model accuracy is better than this mean validation error.

In some embodiments, the processor set is further configured to determine a similarity value based on a comparison of the training sample and the next training sample, and in response to the similarity value being less than a threshold similarity value, additionally skip executing of the ML model on the next training sample based on the similarity and retrieve a second next training sample from the training set based on the additionally skipping. The technical advantage of this feature is that additional execution cost and bandwidth can be conserved on a next training sample that is similar to a previous training sample for which the ML model is already accurately predicting a projected output.

In some embodiments, the processor set is further configured to present a notification on a computer, wherein the notification indicates that the back propagation process is being skipped. The technical effect of this feature is enabling a supervising user to understand that the model is accurate with respect to some of the samples, enabling the supervising user to have a better understanding of the model accuracy.

According to an aspect of the example embodiments, there is provided a method that includes storing a validation function and a training set comprising a plurality of training samples, executing a machine learning (ML) model on the plurality of training samples using a software application during an epoch of a multi-epoch training process performed by the software application, wherein the executing includes retrieving a training sample from the training set, executing the ML model on the training sample to generate a model prediction for the training sample, determining an accuracy of the ML model for the training sample based on the model prediction, an expected output, and the validation function, skipping a back propagation process of the ML model for the training sample based on the accuracy exceeding a pre-determined threshold value, and retrieving a next training sample from the training set based on the skipping. The method has the technical effect of reducing the processing time and cost for training a ML model on samples for which the model is already well-trained (e.g., accurate). A technical advantage of the apparatus is that the overall model training time can be reduced and bandwidth on the training platform can be conserved in comparison to a traditional model training process in which back propagation is always performed.

In some embodiments, the skipping includes skipping execution of a loss function on the model prediction of the training sample to compute a loss for the ML model and skipping updating weights of the ML model based on the loss. The technical advantage of this feature is that the loss function does not need to be executed and the calculated loss does not need to be propagated back through the ML model thereby conserving significant execution cost and time.

In some embodiments, the method further includes executing the ML model on a validation set during a previous epoch of the multi-epoch training process to determine the validation function. The technical effect of this feature is that the previous epoch of the training process can be used to determine the validation function for determining whether to skip back propagation of a training sample.

In some embodiments, the method further includes executing the ML model on the next training sample to generate a next model prediction for the next training sample, determining an additional accuracy of the ML model based on the next model prediction, an expected model output of the next model prediction, and the validation function, and executing the back propagation process of the ML model for the next training sample based on the additional accuracy not exceeding the pre-determined threshold value. The technical effect of this feature is that the decision on whether to skip the back propagation process can be selective/dynamic based on an accuracy of the ML model on a particular training sample.

In some embodiments, the method further includes determining the next training sample is a last training sample in the training set, and in response, executing the ML model on a plurality of validation samples in a validation set to generate additional model predictions for the plurality of validation samples, determining a mean validation error of the ML model based on the additional model predictions and expected outputs of the plurality of validation samples, and updating the validation function using the determined mean validation error. The technical effect of this feature is that the mean validation error can be determined using the same validation function used to validate an individual training sample after feed forwarding the training sample through the ML model. Another technical effect of this feature is that the mean validation error can be used to update the validation function such that back propagation processing can be skipped for subsequent training samples whose determined model accuracy is better than this mean validation error.

In some embodiments, the method further includes determining a similarity value based on a comparison of the training sample and the next training sample, and in response to the similarity value being less than a threshold similarity value, additionally skipping executing of the ML model on the next training sample based on the similarity and retrieving a second next training sample from the training set based on the additionally skipping. The technical advantage of this feature is that additional execution cost and bandwidth can be conserved on a next training sample that is similar to a previous training sample for which the ML model is already accurately predicting a projected output.

In some embodiments, the method further includes presenting a notification on a computer, wherein the notification indicates that the back propagation process is being skipped. The technical effect of this feature is enabling a supervising user to understand that the model is accurate with respect to some of the samples, enabling the supervising user to have a better understanding of the model accuracy.

According to an aspect of the example embodiments, there is provided a computer program product that includes a set of one or more computer-readable storage media, and program instructions, stored in the set of one or more computer-readable storage media, for causing a processor set to perform computer operations that includes storing a validation function and a training set comprising a plurality of training samples, executing a machine learning (ML) model on the plurality of training samples using a software application during an epoch of a multi-epoch training process performed by the software application, wherein the executing includes retrieving a training sample from the training set, executing the ML model on the training sample to generate a model prediction for the training sample, determining an accuracy of the ML model for the training sample based on the model prediction, an expected output, and the validation function, skipping a back propagation process of the ML model for the training sample based on the accuracy exceeding a pre-determined threshold value, and retrieving a next training sample from the training set based on the skipping. The method has the technical effect of reducing the processing time and cost for training a ML model on samples for which the model is already well-trained (e.g., accurate). A technical advantage of the apparatus is that the overall model training time can be reduced and bandwidth on the training platform can be conserved in comparison to a traditional model training process in which back propagation is always performed.

In some embodiments, the skipping includes skipping execution of a loss function on the model prediction of the training sample to compute a loss for the ML model and skipping updating weights of the ML model based on the loss. The technical advantage of this feature is that the loss function does not need to be executed and the calculated loss does not need to be propagated back through the ML model thereby conserving significant execution cost and time.

In some embodiments, the processor set is further configured to perform executing the ML model on a validation set during a previous epoch of the multi-epoch training process to determine the validation function. The technical effect of this feature is that the previous epoch of the training process can be used to determine the validation function for determining whether to skip back propagation of a training sample.

In some embodiments, the processor set is further configured to perform executing the ML model on the next training sample to generate a next model prediction for the next training sample, determining an additional accuracy of the ML model based on the next model prediction, an expected model output of the next model prediction, and the validation function, and executing the back propagation process of the ML model for the next training sample based on the additional accuracy not exceeding the pre-determined threshold value. The technical effect of this feature is that the decision on whether to skip the back propagation process can be selective/dynamic based on an accuracy of the ML model on a particular training sample.

In some embodiments, the processor set is further configured to perform determining the next training sample is a last training sample in the training set, and in response, executing the ML model on a plurality of validation samples in a validation set, determining a mean validation error of the plurality of validation samples based on predicted outputs of the plurality of validation samples and expected outputs of the plurality of validation samples, and updating the validation function using the mean validation error. The technical effect of this feature is that the mean validation error can be determined using the same validation function used to validate an individual training sample after feed forwarding the training sample through the ML model. Another technical effect of this feature is that the mean validation error can be used to update the validation function such that back propagation processing can be skipped for subsequent training samples whose determined model accuracy is better than this mean validation error.

In some embodiments, the processor set is further configured to perform determining a similarity between the training sample and the next training sample, additionally skipping executing of the ML model on the next training sample based on the similarity, and retrieving a second next training sample from the training set based on the additionally skipping. The technical advantage of this feature is that additional execution cost and bandwidth can be conserved on a next training sample that is similar to a previous training sample for which the ML model is already accurately predicting a projected output.

In some embodiments, the processor set is further configured to perform displaying a notification on a graphical user interface (GUI) of the software application which indicates that the back propagation process is being skipped. The technical effect of this feature is enabling a supervising user to understand that the model is accurate with respect to some of the samples, enabling the supervising user to have a better understanding of the model accuracy.

The example embodiments are a training process and a training application for training a machine learning model such as an artificial intelligence model with a neural network capability. The training process is new in that one or more steps of a traditional training process may be omitted/skipped by validating an accuracy of individual training samples that are processed by the model during training. According to various aspects, a validation function that is traditionally used for validating the ML model when executing on a validation set during a validation portion of an epoch can be used to validate a training sample that is executed by the ML model during a training portion of the epoch. This enables the process to detect when the ML model is already generating an accurate output/prediction for a training sample and skip the back propagation process for the training sample. In other words, the process may skip loss computation and model update through the back propagation process because the model is already predicting an accurate output of the training sample. As a result, a significant amount of computation and time can be conserved.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:
On-demand self-service: a cloud consumer can unilaterally provision computing capabilities, such as server time and network storage, as needed automatically without requiring human interaction with the service's provider.
Broad network access: capabilities are available over a network and accessed through standard mechanisms that promote use by heterogeneous thin or thick client platforms (e.g., mobile phones, laptops, and PDAs).
Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).
Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.
Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:
Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure, including network, servers, operating systems, storage, or even individual application capabilities, with the possible exception of limited user-specific application configuration settings.
Platform as a Service (PaaS): the capability provided to the consumer is to deploy onto the cloud infrastructure consumer-created or acquired applications created using programming languages and tools supported by the provider. The consumer does not manage or control the underlying cloud infrastructure, including networks, servers, operating systems, or storage, but has control over the deployed applications and possibly application hosting environment configurations.
Infrastructure as a Service (IaaS): the capability provided to the consumer is to provision processing, storage, networks, and other fundamental computing resources where the consumer can deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:
Private cloud: the cloud infrastructure is operated solely for an organization. It may be managed by the organization or a third party and may exist on-premises or off-premises.
Community cloud: the cloud infrastructure is shared by several organizations and supports a specific community with shared concerns (e.g., mission, security requirements, policy, and compliance considerations). It may be managed by organizations or a third party and may exist on-premises or off-premises.
Public cloud: the cloud infrastructure is made available to the general public or a large industry group and is owned by an organization selling cloud services.
Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure that includes a network of interconnected nodes.

The instant features, structures, or characteristics as described throughout this specification may be combined or removed in any suitable manner in one or more embodiments. For example, the usage of the phrases “example embodiments,” “some embodiments,” or other similar language, throughout this specification refers to the fact that a particular feature, structure, or characteristic described in connection with the embodiment may be included in at least one embodiment. Thus, appearances of the phrases “example embodiments,” “in some embodiments,” “in other embodiments,” or other similar language, throughout this specification do not necessarily all refer to the same group of embodiments, and the described features, structures, or characteristics may be combined or removed in any suitable manner in one or more embodiments. Further, in the diagrams, any connection between elements can permit one-way and/or two-way communication even if the depicted connection is a one-way or two-way arrow. Also, any device depicted in the drawings can be a different device. For example, if a mobile device is shown sending information, a wired device could also be used to send the information.

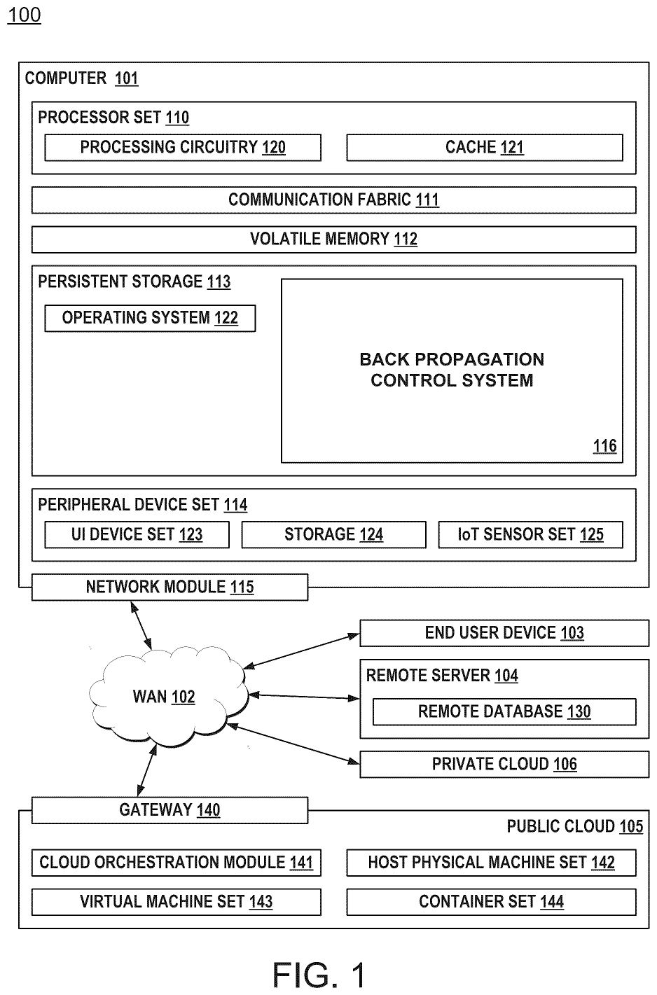

FIG. 1 illustrates a computing environment 100 according to an embodiment of the instant solution. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again, depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Referring to FIG. 1, computing environment 100 contains an example of an environment for executing at least some of the computer code involved in performing the inventive methods, such as a back propagation control system 116. In addition to block 116, computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 116, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smartphone, smartwatch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, the performance of a computer-implemented method may be distributed among multiple computers and/or between multiple locations. On the other hand, in this presentation of the computing environment 100, a detailed discussion is focused on a single computer, specifically the computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is a memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 116 in persistent storage 113.

COMMUNICATION FABRIC 111 is the signal conduction path that allows the various components of computer 101 to communicate with each other. Typically, this fabric comprises switches and electrically conductive paths, such as the switches and electrically conductive paths that make up buses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 116 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth® connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smartwatches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi® signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data now known or to be developed in the future. In some embodiments, the WAN may be replaced and/or supplemented by local area networks (LANs) designed to communicate data between devices located in a local area, such as a Wi-Fi® network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, this data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanations of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as communicating with WAN 102, in other embodiments, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both parts of a larger hybrid cloud.

The example embodiments are directed to a training platform for training a machine learning (ML) model such as a neural network, a deep neural network, or other AI model. The system can execute the ML model on a training sample of data during a feed forward process to generate a predicted output. Prior to performing a back propagation process, the predicted output can be compared to an expected output. Furthermore, a validation function can be applied to the comparison of the predicted output and the expected output to determine an accuracy of the ML model with respect to the training sample. When the accuracy is better than a threshold, the back propagation process can be skipped/omitted for this training sample because the ML model already has a good understanding of this example.

As an example, a validation function may be a validation metric, a mean validation metric, or the like, which can be applied to the comparison of the predicted model output to the expected output to determine the accuracy of the model. For example, a predicted output of the ML model for a training sample may be the number 5.2. The expected output for the training sample may be the number 5. Here, the difference is 0.2, meaning that the prediction is 96% accurate. The validation function may require the model to be at a threshold of at least 90% accuracy. In this example, the model is above the 90% threshold. When the accuracy is better than a predefined threshold, the back propagation process can be skipped.

Detailed descriptions of the model training platform and the model training process in the instant solution are further described and depicted herein.

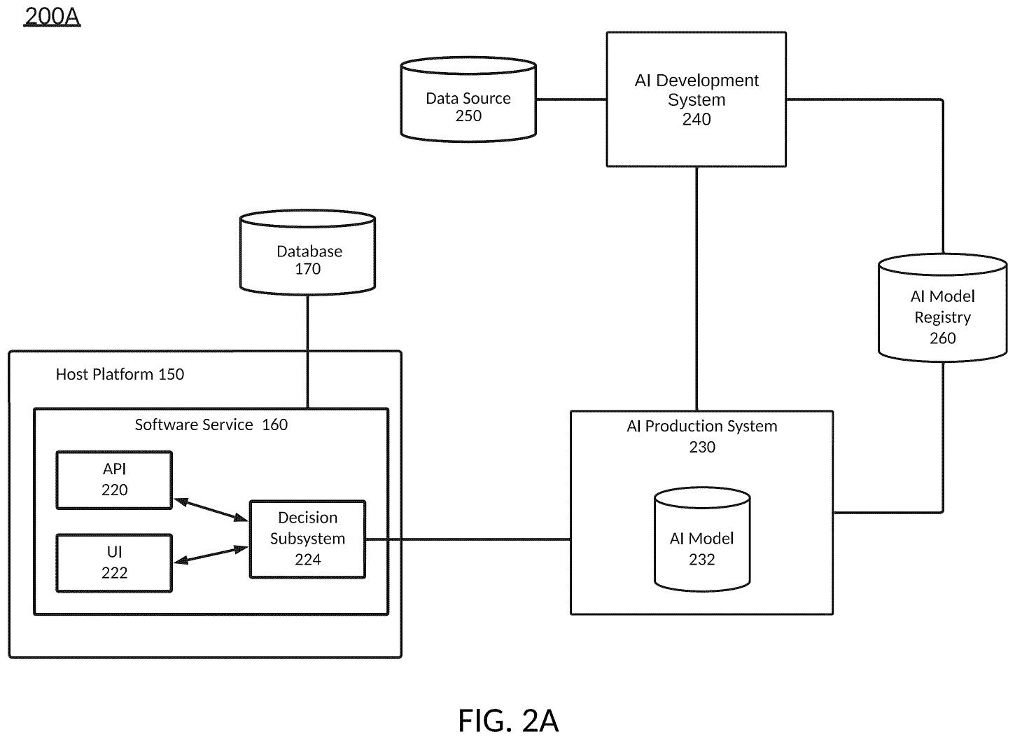

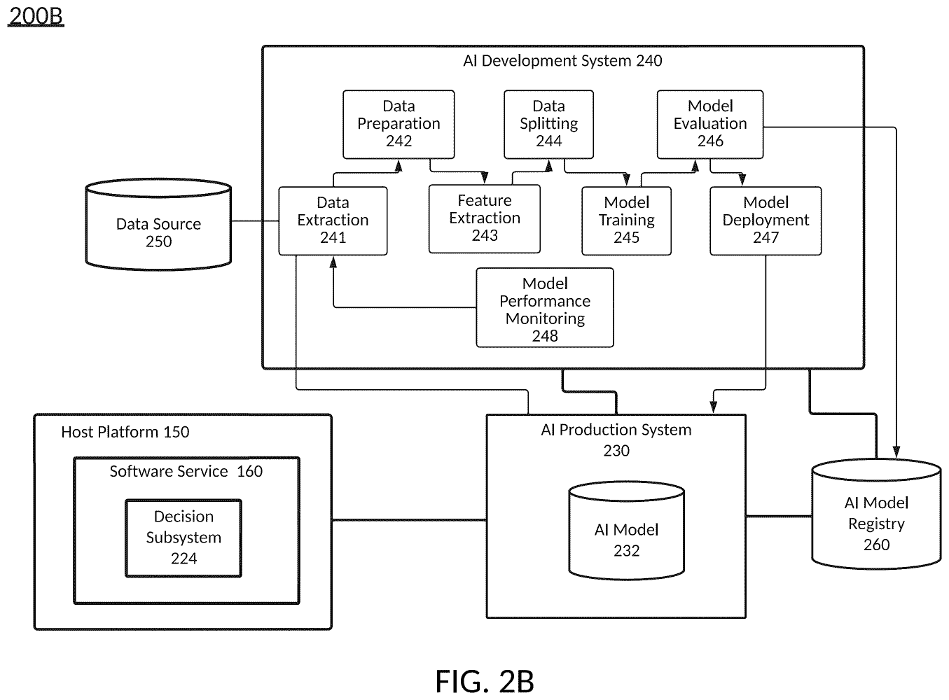

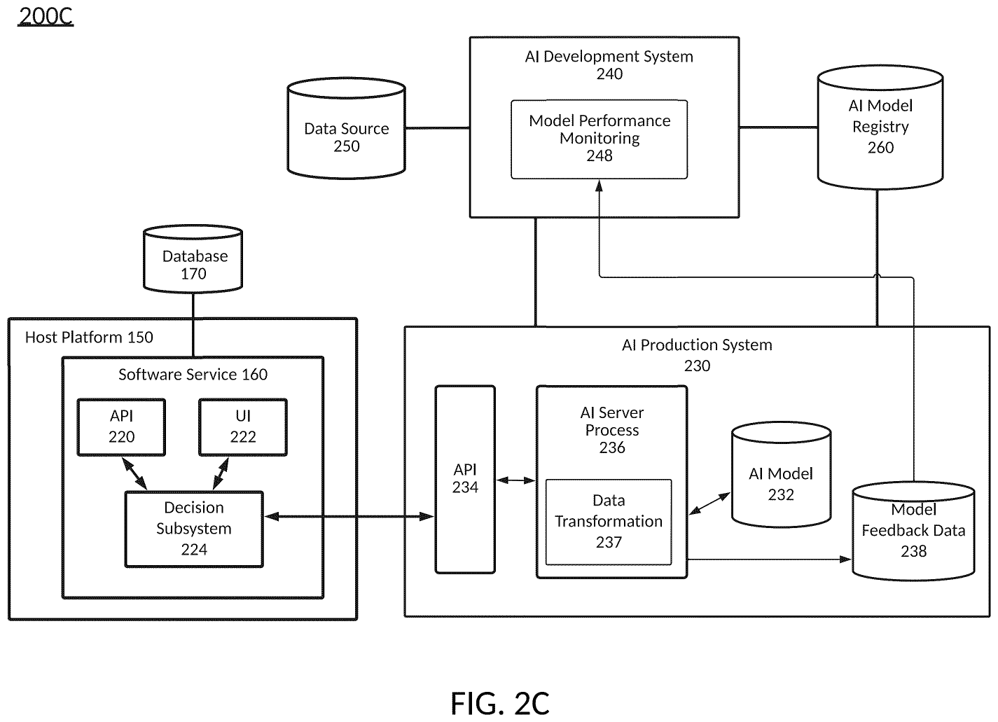

FIG. 2A illustrates an artificial intelligence (AI) network diagram 200A that supports AI-assisted decision points in a software service executing on a computer. While the example instant solution shown utilizes a neural network, which is a type of machine learning (ML) model, other branches of AI, such as, but not limited to, computer vision, fuzzy logic, expert systems, deep learning, generative AI, and natural language processing, may be employed in developing the AI model in this instant solution. Further, the AI model included in these examples and features of the instant solution is not limited to particular AI algorithms. Any algorithm or combination of algorithms related to supervised learning may be employed.

The AI models, ML models, neural networks, and other branches of AI, described and/or depicted herein, build upon the fundamentals of predecessor technologies and form the foundation for all future technological advancements in artificial intelligence. An AI classification system describes the stages of AI progression and advancement. The first classification is known as “reactive machines,” followed by present-day AI classification “limited memory machines” (also known as “artificial narrow intelligence”), then progressing to “theory of mind” (also known as “artificial general intelligence”) and reaching the AI classification “self-aware” (also known as “artificial superintelligence”). Present-day limited memory machines are a growing group of AI models built upon the foundation of their predecessors, reactive machines. Reactive machines emulate human responses to stimuli; however, they are limited in their capabilities as they cannot typically learn from prior experience. Once the AI model's learning abilities emerged, its classification was promoted to limited memory machines. In this present-day classification, AI models learn from large volumes of data, detect patterns, solve problems, generate, and predict data, and the like, while inheriting all the capabilities of reactive machines.

Examples of AI models classified as limited memory machines include, but are not limited to, chatbots, virtual assistants, machine learning, neural networks, deep learning, natural language processing, generative AI models, and any future AI models that are yet to be developed possessing characteristics of limited memory machines.

For example, a neural network is a type of machine learning model that relies on training data to learn associations and connections, improving its accuracy for performing high speed data classifications, clustering, and other analyses of data. Such neural network capabilities are the foundation of deep learning models today and are becoming the foundational blocks of those yet to be developed.

For example, generative AI models combine limited memory machine technologies, incorporating machine learning and deep learning, forming the foundational building blocks of future AI models. For example, theory of mind is the next progression of AI that may be able to perceive, connect, and react by generating appropriate reactions in response to an entity with which the AI model is interacting; all these theory of mind capabilities rely on the fundamentals of generative AI. Furthermore, in an evolution into the self-aware classification, AI models will be able to understand and evoke emotions in the entities with which they interact, as well as possessing their own emotions, beliefs, and needs, all of which rely on generative AI fundamentals of learning from experiences to generate and draw conclusions about itself and its surroundings.

AI models may include, but are not limited to, at least one machine learning model, neural network model, deep learning model, generative AI model, or any combination of models from the branches of AI. AI models are integral and core to future artificial intelligence models. As described herein, AI model refers to present-day AI models and future AI models.

In some embodiments, software service 160 (see FIG. 2A), executing on host platform 150 (see FIG. 2A) provides one or more application programming interfaces (APIs) 220 that enable interaction with other software components via a set of data definitions and protocols. In some examples and features of the instant solution, the APIs provided employ Simple Object Access Protocol (SOAP), Remote Procedure Calls (RPC), and/or Representational State Transfer (REST) techniques. In some examples and features of the instant solution, the plurality of APIs 220 send data to one or more decision subsystems 224 of the software service 160 to assist in decision-making. In some examples and features of the instant solution, the software service 160 stores data included in API requests or data generated during processing the API requests into one or more databases 170 (see FIGS. 1, 2A).

In at least some embodiments, software service 160 provides one or more user interfaces (UIs) 222, such as a server-side hosted graphical user interface (GUI). In some examples and features of the instant solution, the UIs 222 provided employ template-based frameworks, component-based frameworks, etc. In some examples and features of the instant solution, these UIs 222 send data to one or more decision subsystems 224 of the software service 160 to assist with decision-making. In some examples and features of the instant solution, the software service 160 stores data included in UI requests or data generated during processing the UI requests into one or more databases 170.

In at least some embodiments, software service 160 includes one or more decision subsystems 224 that drive a decision-making process of the software service 160. In some examples and features of the instant solution, the decision subsystems 224 receive data from one or more APIs 220 as input into the decision-making process. In some examples and features of the instant solution, a decision subsystem 224 receives data from one or more UIs 222 as input to the decision-making process. In some embodiments, a decision subsystem 224 gathers service configuration or historical execution data from one or more databases 170 to aid in the decision-making process. In some embodiments, a decision subsystem 224 provides feedback to an API 220 or a UI 222.

In at least some embodiments, an AI production system 230 is used by a decision subsystem 224 in a software service 160 to assist in its decision-making process. The AI production system 230 includes one or more AI models 232 that are executed to generate a response, such as, but not limited to, a prediction, a categorization, a UI prompt, etc. In some examples and features of the instant solution, an AI production system 230 is hosted on a server. In some examples and features of the instant solution, the AI production system 230 is cloud-hosted. In some examples and features of the instant solution, the AI production system 230 is deployed in a distributed multi-node architecture.

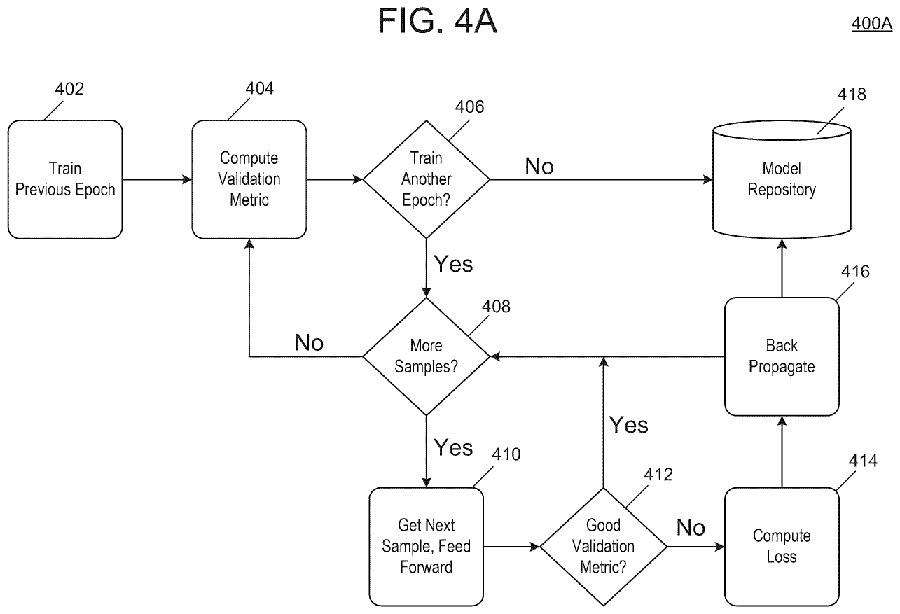

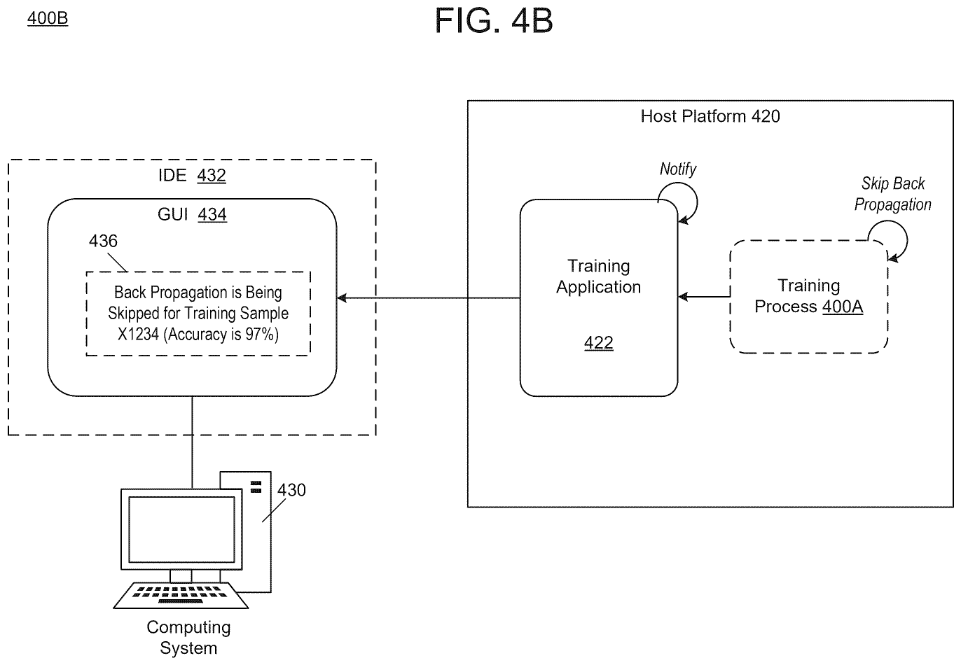

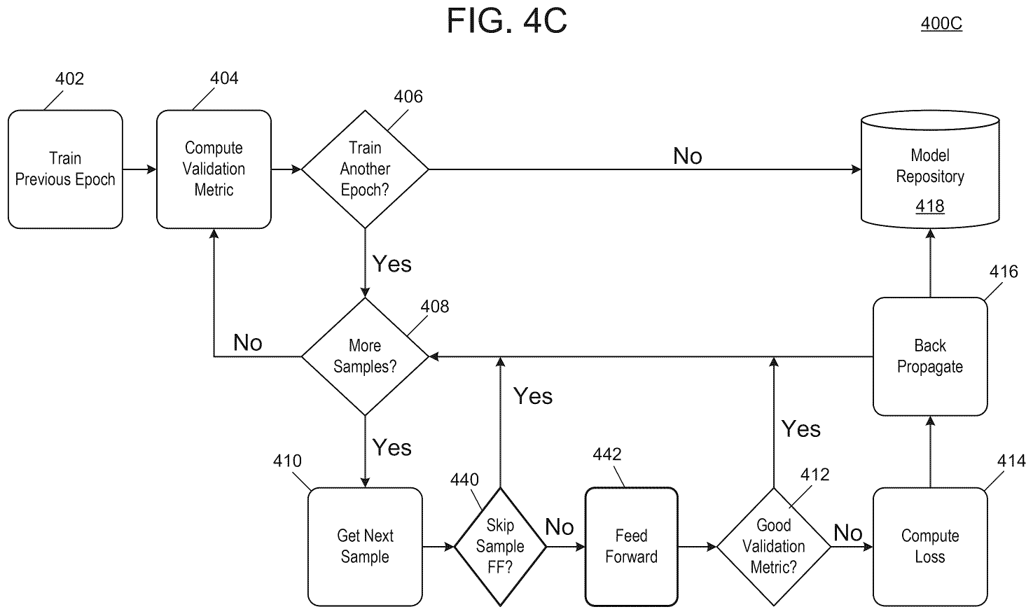

An AI development system 240 creates one or more AI models 232. In some examples and features of the instant solution, the AI development system 240 utilizes data from one or more data sources 250 to develop and train one or more AI models 232. Detailed examples of the training process according to example embodiments can be found in FIGS. 4A-4C, and the like. The data sources 250 may be local or third-party data sources. Further, the data provided by the data sources may be real-world or synthetic. In some examples and features of the instant solution, the AI development system 240 utilizes feedback data from one or more AI production systems 230 for new model development and/or existing model re-training. In some examples and features of the instant solution, the AI development system 240 resides and executes on a server. In some examples and features of the instant solution, the AI development system 240 is cloud hosted. In some examples and features of the instant solution, the AI development system 240 is deployed in a distributed multi-node architecture. In some examples and features of the instant solution, the AI development system 240 utilizes a distributed data pipeline/analytics engine.

In at least some embodiments, after an AI model 232 has been trained and validated in the AI development system 240, it is stored in an AI model registry 260 for retrieval by either the AI development system 240 and/or by one or more AI production systems 230. The AI model registry 260 resides in a dedicated server in one example of the instant solution. In some examples and features of the instant solution, the AI model registry 260 is cloud-hosted. In some examples and features of the instant solution, the AI model registry 260 resides in the AI production system 230. In some examples and features of the instant solution, the AI model registry 260 is a distributed database.

FIG. 2B illustrates a process 200B for developing one or more AI models that support AI-assisted decision points. An AI development system 240 executes steps to develop an AI model 232 that begin with data extraction 241, in which data is loaded and ingested from one or more data sources 250. In some examples and features of the instant solution, historical model feedback data is extracted from one or more AI production systems 230.

Once the data has been extracted during data extraction 241, the extracted data undergoes data preparation 242 for model training. In some examples and features of the instant solution, this step involves statistical testing of the data to see how well it reflects real-world events, its distribution, the variety of data in the dataset, etc. The results of this statistical testing in some embodiments leads to one or more data transformations being employed to normalize one or more values in the dataset. In some examples and features of the instant solution, data deemed to be noisy is cleaned. A noisy dataset includes values that do not contribute to the training, such as, but not limited to, null and long string values. Data preparation 242 may be a manual process or an automated process using one or more of the elements and/or functions described and/or depicted herein.

Features of the data are identified and extracted during the feature extraction step 243. In some examples and features of the instant solution, a feature of the data is internal to the prepared data from the data preparation step 242. In some examples and features of the instant solution, a feature of the data requires a piece of prepared data from the data preparation step 242 to be enriched by data from another data source to be useful in developing the AI model 232. In some examples and features of the instant solution, identifying features may be a manual process or an automated process using one or more of the elements and/or functions described and/or depicted herein. Once the features have been identified, the values of the features are collected into a dataset that will be used to develop the AI model 232.

The dataset (e.g., features and corresponding values of the features) that is output from the feature extraction step 243 is split 244 into a training and validation data set. The training data set is used to train the AI model 232, and the validation data set is used to evaluate the performance of the AI model 232 on unseen data.

The AI model 232 is trained and tuned 245 using the training data set from the data splitting step 244. In this step, the training data set is provided to an AI algorithm and an initial set of algorithm parameters. The training data set includes samples and respective labels for those samples. The AI algorithm and its parameters are typically adjusted to help the AI model 232 correctly predict a label in response to the AI model 232 receiving, as input, the sample that corresponds to that label. The performance of the AI model 232 is then tested within the AI development system 240 utilizing the validation data set from step 244. These steps may be repeated with adjustments to one or more algorithm parameters until the model's performance is acceptable based on various goals and/or results.

The AI model 232 is evaluated 246 in a staging environment (not shown) that resembles the target AI production system 230. This evaluation uses a validation dataset to ensure the performance in an AI production system 230 matches or exceeds expectations. In some examples and features of the instant solution, the validation dataset from step 244 is used. The validation dataset includes samples and respective labels for those samples. The AI model 232 is scored in its ability to correctly predict a label in response to the AI model 232 receiving, as input, the sample that corresponds to that label. In some examples and features of the instant solution, one or more unseen validation datasets are used. In some examples and features of the instant solution, the staging environment is part of the AI development system 240, and the staging environment is managed separately from the AI development system 240. Once the AI model 232 has been validated (e.g., has a success or accuracy rate that exceeds a pre-determined threshold), it is stored in an AI model registry 260, where it can be retrieved for deployment and future updates. In some examples and features of the instant solution, the model evaluation step 246 may be a manual process or an automated process using one or more of the elements and/or functions described and/or depicted herein.

In some examples and features of the instant solution, the AI development system 240 includes a user interface (not shown). The user interface may be used to manage the development system infrastructure, the steps 241-248 within the development system, the interim data transmitted between the various steps 241-248, and/or the data sources 250.

Once an AI model 232 has been validated and published to an AI model registry 260, it may be deployed during the model deployment step 247 to one or more AI production systems 230. In some examples and features of the instant solution, the performance of deployed AI model 232 is monitored 248 by the AI development system 240. In some examples and features of the instant solution, AI model 232 feedback data is provided by the AI production system 230 to enable model performance monitoring 248, and the AI development system 240 periodically requests feedback data for model performance monitoring 248, which includes one or more triggers that result in the AI model 232 being updated by repeating steps 241-248 with updated data from one or more data sources 250.

FIG. 2C illustrates a process 200C for utilizing an AI model that supports AI-assisted decision points. As stated previously, the AI model utilization process depicted herein reflects ML, which is a particular branch of AI, but this instant solution is not limited to ML and is not limited to any AI algorithm or combination of algorithms.

Referring to FIG. 2C, in at least some embodiments an AI production system 230 is used by a decision subsystem 224 in software service 160 to assist in its decision-making process. The AI production system 230 provides an API 234, executed by an AI server process 236 through which requests can be made. In some examples and features of the instant solution, a request may include an AI model 232 identifier to be executed based on the type of request. In some examples and features of the instant solution, a data payload (e.g., to be input to the AI model during execution) is included in the request. The data payload may include API 220 data from software service 160, UI 222 data from software service 160 and/or data from other software service 160 subsystems (not shown).

In at least some embodiments upon receiving the API 234 request, the AI server process 236 transforms 237 the data payload or portions of the data payload to be valid feature values in an AI model 232. In various embodiments, data transformation 237 includes, but is not limited to, combining data values, normalizing data values, and/or enriching the incoming data with data from other data sources 250. Once the data transformation occurs, the AI server process 236 executes the appropriate AI model 232 using the transformed input data. Upon receiving the execution result, the AI server process 236 responds to the API requester, which is a decision subsystem 224 of software service 160. In some examples and features of the instant solution, the response may result in an update to a UI 222 in software service 160. In some examples and features of the instant solution, the response includes a request identifier that can be used later by the software service 160 to provide feedback on the performance of the AI model 232. In some examples and features of the instant solution, a model feedback record may be added into model feedback data 238 (that is stored in a computer memory storage) by the AI server process 236.

In some examples and features of the instant solution, the API 234 includes an interface to provide AI model 232 feedback after an AI model 232 execution response has been processed. This mechanism enables the requester to provide feedback on the accuracy of the AI model 232 results. In some examples and features of the instant solution, the feedback interface includes the identifier of the initial request so that it can be used to associate the feedback with the request. Upon receiving a call into the feedback interface of the API 234, the AI server process 236 creates and adds a model feedback record into the model feedback data 238 which holds historical model feedback records. In some examples and features of the instant solution, the records in this model feedback data 238 are provided to model performance monitoring 248 in the AI development system 240. This model feedback data is streamed to the AI development system 240 or may be provided upon request. In some examples and features of the instant solution, the model feedback records in the model feedback data 238 are used as an input for retraining the AI model 232.

In some examples and features of the instant solution, the AI production system 230 includes a user interface (not shown). The user interface may be used to manage the production system infrastructure, the components of the production system 230-238, and/or the operation of the AI production system and its components.

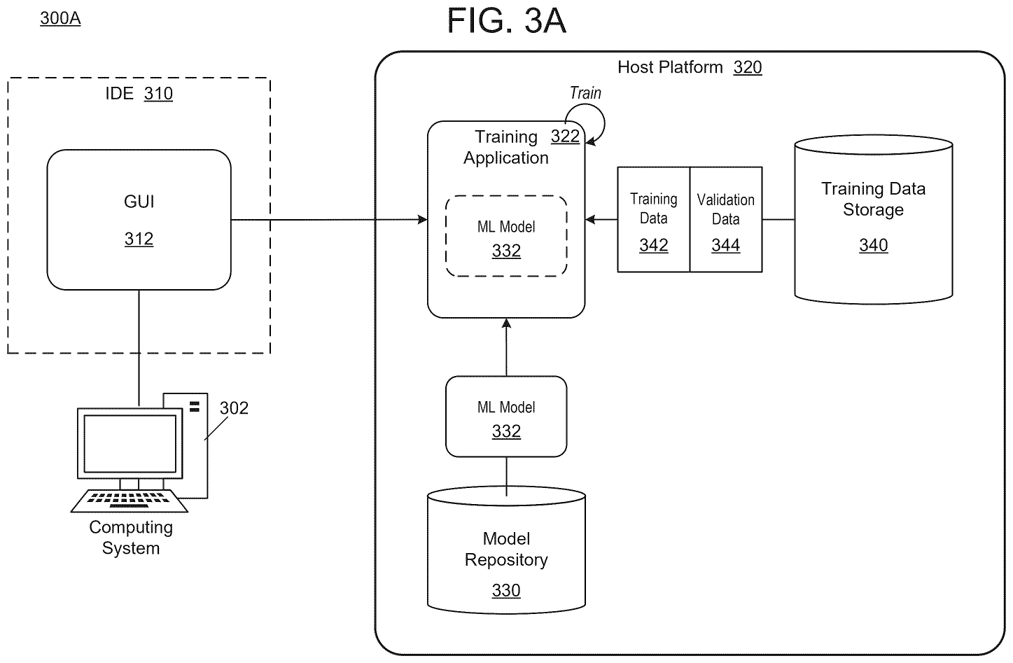

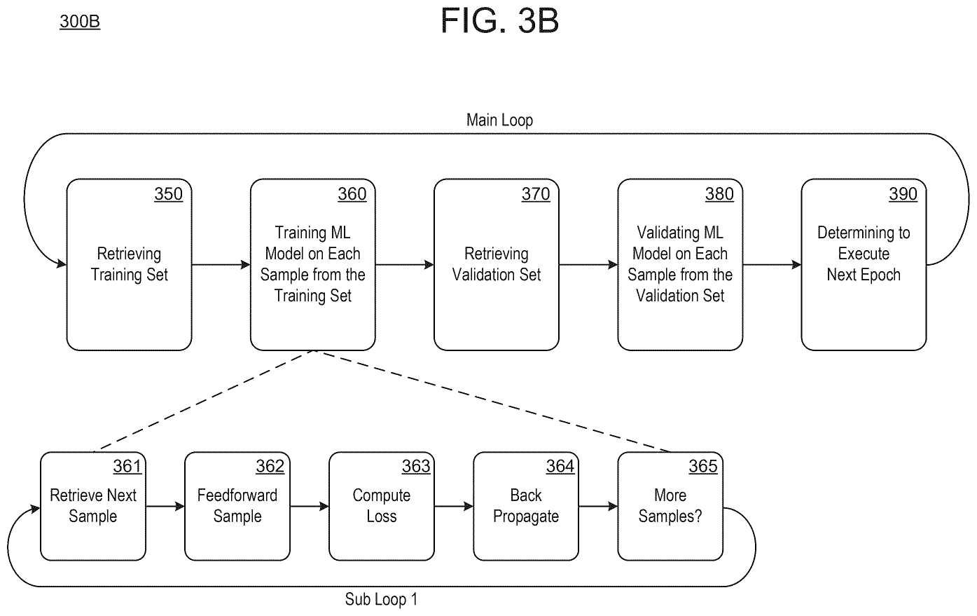

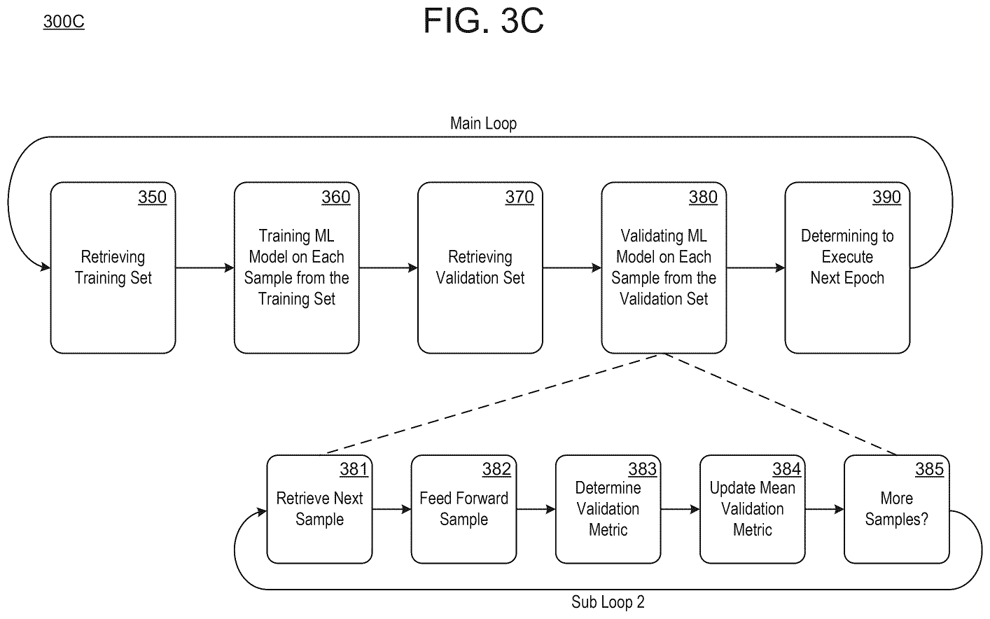

FIGS. 3A-3C are diagrams illustrating a multi-epoch training process according to examples and features of the instant solution. For example, FIG. 3A illustrates a computing environment 300A in which model training may be performed. Referring to FIG. 3A, a host platform 320 such as a cloud platform, a web server, a database, and/or the like, hosts a training application 322 capable of training an artificial intelligence (AI)/machine learning (ML) model, or the like. In the remaining examples, an ML model is described, however, it should be appreciated that the model may be an AI model, or the like. The host platform 320 also includes a training data storage 340 and a model repository 330. Training data and validation data for training and validating a model are stored within the training data storage 340. Meanwhile, AI models, ML models, etc. are stored within the model repository. A validation function as described herein is stored within computer data memory/storage such as the training data storage 340 and/or the model repository 330 so as to be accessible and retrievable.

In the example of FIG. 3A, a remote computer (e.g., computing system 302) connects to the host platform 320 via a network such as the Internet, a private network, or the like. Here, the computing system 302 may access the training application 322 hosted by the host platform 320 by inputting a URL or other address of the training application 322 into a web browser on the computing system 302. As another example, a front-end of the training application 322 includes an integrated development environment (IDE) 310 where an ML model may be developed, trained, validated, tested, retrained, and the like. The IDE 310 may include a graphical user interface (GUI) 312 where programming code may be input and used to develop the model. The IDE 310 may be stored and/or installed on the computing system 302 enabling the computing system 302 to communicate with the training application 322 on the host platform 320 using the front-end on the computing system 302.

In the example of FIG. 3A, the computing system 302 requests to train (or retrain) an ML model 332 via the training application 322. Here, the training application 322 may retrieve the ML model 332 from the model repository 330. Furthermore, during training, the training application 322 may query training data 342 from the training data storage 340 and input the training data 342 into the ML model 332 as an input. The ML model 332 may generate predictions for the training samples in the training data 342. A loss may be computed and used to back propagate changes to the ML model 332 including changes to weights, etc. This process may be iteratively repeated until all training samples in the training data 342 have been executed by the ML model 332 and the ML model 332 achieves a prediction performance (with respect to the training data 342) that exceeds a pre-determined threshold.

Next, the training application 322 queries the training data storage 340 for validation data 344 which includes a plurality of validation samples. In this case, the training application 322 inputs the validation data (e.g., the plurality of validation samples) into the ML model 332 as inputs, and generates predictions for samples of the validation data. Next, the training application 322 may compare the predictions to expected outputs for the validation samples. The training application 322 may determine a validation metric based on the comparison, and determine an accuracy of the model based on a validation function.

For an example, the validation metric is an accuracy of the ML model 332 which can be determined for each validation sample. Meanwhile, the validation function may require the accuracy to be above a predefined threshold such as 95%, 90%, or the like. Furthermore, an average or mean (e.g., mean absolute percentage error (MAPE), etc.) of the accuracy of the ML model 332 may be determined based on the entire validation set to determine an overall accuracy of the ML model 332. When the accuracy has reached a desired stopping point, the training of the ML model 332 may be completed and the ML model 332 may be stored in the model repository with a flag to indicate that the model is trained. The results of the training may be displayed on the GUI 312 of the IDE 310 running with the computing system 302.

FIG. 3B illustrates a process 300B of executing an epoch of a multi-epoch training process for training an ML model according to example embodiments. Referring to FIG. 3B, the epoch includes an iterative process (e.g., a loop) that includes retrieving a training data set in 350, training the ML model on the training data set in 360, retrieving a validation data set in 370, validating the accuracy of the ML model based on the validation set in 380, and determining whether to execute another epoch in 390. This process may be iteratively repeated until the training data is gone, the ML model reaches a certain threshold of accuracy through the validation, a time limit, or the like.

In this example, the training data (including a plurality of training samples) may be retrieved from the training data storage 340 shown in FIG. 3A. Here, the training data set may include a plurality of training samples, for example, 10,000 samples, 100,000 samples, 1,000,000 samples, etc. Each sample may include an expected output that can be compared to the output generated by the ML model based on execution of the ML model on the training set. In 360, the training of the ML model may be performed. During the training, each training sample may be input to the ML model to generate a prediction. This inputting may be performed as a batch or other mechanism in which all of the training samples are input to the ML model.

In the example of FIG. 3B, the training step 360 includes a sub-loop of steps which include retrieving a next sample in 361, feedforwarding the next sample through the ML model to generate a prediction in 362, computing a loss of the ML model in 363, back propagation based on the loss in 364, and determining whether more samples exist in 365. For example, the feedforwarding performed in 362 may include providing a training sample as an input to the ML model and feeding it through the network, until the model's ‘prediction’ (or inference result) is achieved. This is very similar to how a fully-trained model will perform predictions; however during training, additional temporary information may be stored to make training more efficient.

After the prediction (inference result) is determined for the training sample, in 363 the ML model ‘loss’ is computed, which computes a measure of how far away the model's prediction is from the expected result. The loss function is differentiable meaning its derivative can be computed with respect to model parameters. The differentiable loss function is helpful for neural network learning, because it can compute a gradient, which provides a direction of the difference (e.g., positive or negative) and by how much individual network weights of the ML model need to be adjusted such that next time it can perform a better prediction. An example of a differentiable loss function is mean squared error (MSE), and the like. In 364, the loss is propagated back through the network of the ML model adjusting network weights in each of the layers appropriately. Back propagation is traditionally the most expensive step of the sub loop from the perspective of computation and time.

The sub loop may be iteratively performed until all training samples in the training data set have been fed through the ML model, the error has been computed and back propagated through the model, and the like.

FIG. 3C illustrates a process 300C of executing a second sub loop for the epoch for validating the ML model according to example embodiments. Referring to FIG. 3C, after the training process is performed and completed in 360, the system (e.g., training application, etc.) retrieves a validation set from the training data storage in 370, and executes a validation process of the ML model in 380. The validation process includes a second sub loop. The second sub loop includes retrieving a next sample from the validation set in 381, feed forwarding the sample through the network of the ML model in 382 to generate a prediction for the ML model, determining a validation metric based on the prediction by the ML model and an expected output for the validation sample in 383, updating a mean validation metric in 384 with the validation metric determined in 383, and determining if more validation samples exist in the validation set in 385.

The second sub loop may be iteratively determined until all validation samples in the validation set have been fed through the ML model and validation metrics have been determined for each sample, and used to update the mean validation metric.

The end of the epoch includes determining whether to execute another epoch in 390. After each epoch of training, the overall model accuracy is typically evaluated using a validation function. For this, a model prediction (e.g., applying a similar approach as that done during feed-forward processing) is computed for each sample in the validation set, and an overall or mean validation metric is then often already computed. This validation metric is often already computed since it is typically used for early-stopping (e.g., if the validation metric stops improving, the model predictions are not getting better as far as the user of the model is concerned). In this case, early-stopping would be applied to stop training.

According to various embodiments, the back propagation process performed during the loop in the training process described herein may be more computationally intensive than the other steps performed during the training process. For example, during back propagation, a loss function is executed on the model's predictions and the expected model output. The loss function determines how far away the model's prediction is from the expected model output. An example of such a function is the Mean Squared Error (MSE). Furthermore, the model is updated through the back propagation process based on the loss computed through the loss function. The update process includes updating weights within layers of the neural network to compensate for the loss in an effort to achieve a more accurate result by the neural network during subsequent executions.

According to various embodiments, the back propagation process may be skipped in some embodiments. For example, the training software described herein receives the model's prediction(s) from the feed forward step being performed on a training sample, and determines a validation metric for the training sample based on a difference between the model's predictions and the expected model output. Using a validation function that requires the model to meet an accuracy threshold (e.g., be at least 90% accurate), the accuracy of the model prediction for the training sample may be compared to the validation metric to determine if the accuracy is above a threshold. If so, the back propagation process is skipped by the software. The skipping includes skipping the loss computation and the model update. Instead, the process moves ahead to the next training sample, or exits the training step when the training sample is the last in the set, and proceeds to the validation portion of the epoch. The validation function (e.g., the threshold) does not have to be hardcoded. For example, in another embodiment such as when training resources are heavily constrained, the validation function instead compares the model prediction with the previously-computed validation set mean validation error, or median validation error, and determines that the accuracy is sufficient if the validation error of the sample is better than the mean (or median) validation error. Thus, the previous mean validation error is used to update the validation function in some embodiments.

FIG. 4A illustrates a process 400A of skipping a back propagation process during an epoch of training a model according to examples of the features of the instant solution, and FIG. 4B illustrates a process 400B of presenting a notification on a computer, e.g., displaying a notification on a graphical user interface, indicating the back propagation process is being skipped. Referring to FIG. 4A, in 402, the software may train the ML model during a previous epoch. The previous epoch may be the first epoch of a multi-epoch training process, or another epoch. The results of the epoch may be validated in 404. For example, a validation set may be retrieved from storage and input to the ML model.

The ML model may generate predictions for each of the validation samples in the validation set. The predictions are compared to expected outputs to determine a difference, such as a percentage difference between the expected output and the actual output. Each validation sample may result in a percentage difference which may be combined with the other percentage differences of the other validation samples, for example, using mean absolute percentage error (MAPE) or some other function. The resulting MAPE value may represent an average of the model accuracy for the entire validation set. The MAPE value may be compared to a validation threshold (e.g., 95%, etc.) to determine whether or not model training should stop. If the model is at least 95% accurate on average, the training process may be stopped. However, if the model is not that accurate, the training process may be continued.

In FIG. 4A, the system determines whether or not to perform another training epoch in 406. For example, the system may compare the MAPE value of the validation performed in 404 to a predetermined threshold accuracy value to determine if the model is accurate enough. If so, training is terminated and the model is stored in a model repository 418. However, if the model accuracy is not at or above the predetermined accuracy threshold, another training epoch may be performed.

If the determination is to perform another epoch in 406, the next training epoch is started and a training set is obtained from storage. A training loop is then executed. In 408, the system determines whether additional training samples exist in the training set, and if so, in 410, a next training sample is fed as an input to the ML model to generate a model prediction. In 412, the model prediction for the training sample is compared to an expected output to determine a difference. This difference may be used to determine the accuracy of the prediction by the ML model. For example, if the expected output is 10, and the predicted output is 9.5, the ML model may have an accuracy of 95%. This accuracy may be referred to as a validation metric.

A validation function may be applied to the accuracy (validation metric) to determine whether or not the validation metric is good enough (e.g., satisfies a threshold set by the validation function). If so, the back propagation process is skipped and the model m advances to the start of the loop in step 408. However, if the validation metric is below the accuracy threshold of the validation function, the back propagation process may be performed. Here, in 414, the loss of the ML model is computed based on a difference between the model prediction for the training sample and the expected output, and a loss function is applied. The result is updates to the ML model which can be back propagated to the ML model in 416. After back propagation, the system returns to step 408 to look for a next training sample. The loop continues until no more training samples are left in the training set. After the training set is completed, a validation of the epoch is performed in 404, etc.

According to various embodiments, in between the feed-forward and back-propagation steps of training, the ‘loss’ may be computed using the network's loss function. As mentioned, this loss function must be differentiable. The loss is also not directly tied to how well the model predicts for a given sample. Instead, it is often correlated with the accuracy of the prediction (during training, the network accuracy should improve, meaning the computed loss should be decreasing), and ideally the accuracy of predictions as seen by the end user of the model should also improve. In the example embodiments, the system does not look at the loss first. Instead, the system determines a validation metric for the training sample and compares that to a validation function to determine if the accuracy of the model is good enough to skip the back propagation process. For example, the validation function may require the accuracy to be at least 95%. Furthermore, in some embodiments, the mean validation error (such as the MAPE, etc.) may be used to update the validation function. For example, the accuracy threshold may be modified based on the MAPE value of the previous iteration or iterations of the training.

After the feed-forward part of model training, the system may apply the validation function on the training sample's predicted value. The validation function does not need to be differentiable, so there is more freedom in how it can be defined. If the result of applying the validation function on the current sample being trained indicates the model accuracy is good enough (regardless of what the network loss may be), the system can skip the computation of the loss and the expensive back propagation part of model training completely to reduce computational cost of model training. As a result, the most expensive part of model training (back propagation) may only be performed if the validation metric for a sample suggests the prediction accuracy of the model is not good enough. Thus, the learning of the neural network (updating the network weights) is only performed on training samples where the model predictions are poor. If the prediction is poor (as evaluated using the validation metric), then the system will compute the loss and perform back propagation such that the next prediction for this same sample should be improved.

Referring now to FIG. 4B, in step 412, the system may determine to skip the back propagation process and present a notification to a user that is supervising the learning process. For example, the process 400A shown in FIG. 4A, may be executed by a training application 422 hosted by a host platform 420 as shown in the example of FIG. 4B. In this example, when the training application 422 determines to skip the back propagation process, the training application 422 may generate a notification 436 and present the notification 436, e.g., display the notification 436 via a GUI 434 within an integrated development environment (IDE) 432 being accessed by a computing system 430, play audio that expresses the notification on a speaker of the computing system 430, generate a tactile message that expresses the notification on an input/output device of the computing system 430, etc.

The notification 436 may identify the training sample by its name, data identifier, date of creation, etc. Furthermore, the notification 436 may identify the reason why the back propagation process is being skipped. In this case, the reason is because the accuracy is above a predefined threshold set forth by the validation function. In some embodiments, it may not be very helpful to show each training sample for which back propagation is skipped. As another example, the GUI 434 may display/report summary information from a training epoch such as a total number of times back propagation was skipped for a particular epoch, for the process overall, and the like.

FIG. 4C illustrates a process 400C of skipping an entire loop of the training function when the training sample is similar to a previous training sample that the model has already learned according to examples of the features of the instant solution. In this example, the system may perform two extra steps between the step 410 of getting the next sample, and the step 412 of determining the validation metric, as previously described in FIG. 4A. In this example, the system may retrieve the training sample in 410, and determine if the training sample is similar to another training sample that has already had the back propagation process skipped.

For example, the system may convert the training sample into a vector. Here, the training data may include text, audio, image, numbers, etc. and may be transformed into a vector and compared with vectors of previous training samples to determine if the new training sample is similar enough to any of the previous training samples that the new training sample can be skipped. For example, the training sample may be considered similar enough to a previous training sample (and be skipped), if the input features (which are typically represented as a vector of floating point/real values) have identical values between the training sample and a previous training sample. As another example, the training sample may be considered similar enough to a previous training sample (and be skipped) if the input features of the training sample are within a nominal distance from a previous training sample, for example, all input features of the test sample are within 0.1% or 0.01% of the previous training sample. As another example, other common or domain-specific test of similarity may be applied, for example, the cosine similarity between the training sample and a previous training sample may be used to show that the two corresponding vectors are nearly identical, for example, within some tolerance (e.g. 0.1%, 0.01%).

For example, in 440, the system may determine if, for a particular training sample, the particular training sample is similar enough to another training sample previously executed. Here, if the prediction for the similar training sample was already good enough for the system to choose to skip back-propagation for the training sample, the system can try to save even more computation, assuming that the next time the model sees this same training sample it will likely predict the result very well too. Therefore, skipping feed-forward processing, as well as back propagation, the next time the system sees this very-well-predicted training sample can save even more computation. If the particular training sample is not similar enough to a previous training sample that has had its back propagation process skipped, then in 442 the system may feed the training sample through the ML model to generate a model prediction. Furthermore, the remaining steps of the loop shown in FIG. 4A, may now be computed.

In some cases, the model may require that at least a minimum number of training samples have been executed before the system is allowed to skip feed forwarding of a training sample. The system may keep count of each training sample that is executed, and update the count until a predetermined threshold is reached. When the threshold is reached, the system may start determining whether to skip feed forward processing. The count may be kept in a storage system of the training application 422, or the like.

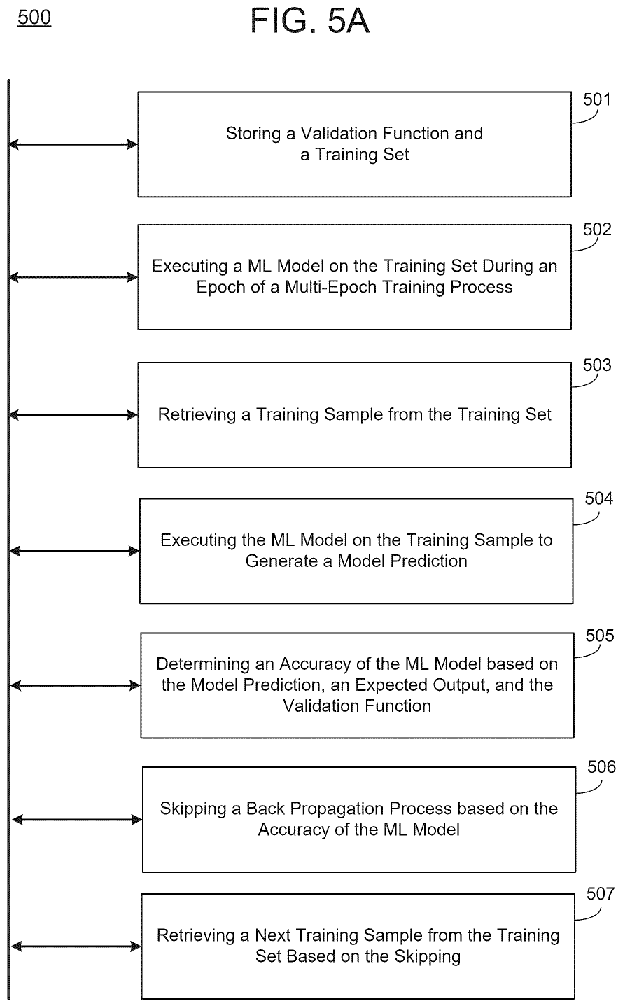

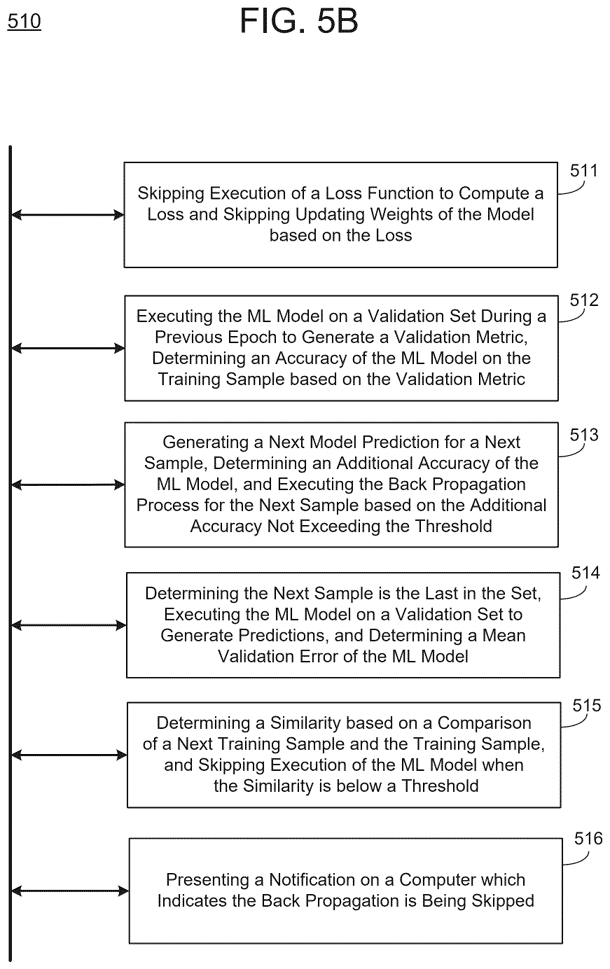

FIG. 5A illustrates a flow diagram of a method 500, according to example embodiments. Referring to FIG. 5A, the method 500 may include storing a validation function and a training set comprising a plurality of training samples in 501. The method may include executing a machine learning (ML) model on the plurality of training samples using a software application during an epoch of a multi-epoch training process performed by the software application in 502. The executing may include retrieving a training sample from the training set in 503. The executing may include executing the ML model on the training sample to generate a model prediction for the training sample in 504. The executing may include determining an accuracy of the ML model for the training sample based on the model prediction, an expected output, and the validation function in 505. The executing may include skipping a back propagation process of the ML model for the training sample based on the accuracy exceeding a pre-determined threshold value in 506. The executing may further include retrieving a next training sample from the training set based on the skipping in 507.

FIG. 5B illustrates a flow diagram of a method 510, according to example embodiments. Referring to FIG. 5B, the method 510 may include skipping execution of a loss function on the model prediction of the training sample to compute a loss for the ML model and skipping updating weights of the ML model based on the loss in 511. The method may further include executing the ML model on a validation set during a previous epoch of the multi-epoch training process to generate a validation metric, wherein the determining the accuracy of the ML model comprises determining a difference between the model prediction and an expected model output, and determining the accuracy of the ML model based on a comparison of the difference to the validation metric in 512.

The method may further include executing the ML model on the next training sample to generate a next model prediction for the next training sample, determining an additional accuracy of the ML model based on the next model prediction, an expected model output of the next model prediction, and the validation function, and executing the back propagation process of the ML model for the next training sample based on the additional accuracy not exceeding the pre-determined threshold value in 513. In some embodiments, the method may further include determining the next training sample is a last training sample in the training set, and in response, executing the ML model on a plurality of validation samples in a validation set to generate additional model predictions for the plurality of validation samples, determining a mean validation error of the ML model based on the additional model predictions and expected outputs of the plurality of validation samples, and updating the validation function using the determined mean validation error in 514.

In some embodiments, the method may further include determining a similarity value based on a comparison of the training sample and the next training sample, and in response to the similarity value being less than a threshold similarity value, additionally skipping executing of the ML model on the next training sample based on the similarity and retrieving a second next training sample from the training set based on the additionally skipping in 515. In some embodiments, the method may further include displaying a notification on a graphical user interface (GUI) of the software application which indicates that the back propagation process is being skipped in 516.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

An exemplary storage medium may be coupled to the processor such that the processor may read information from, and write information to, the storage medium. In the alternative, the storage medium may be integral to the processor. The processor and the storage medium may reside in an application-specific integrated circuit (“ASIC”). In the alternative, the processor and the storage medium may reside as discrete components.

What is claimed is:

1. A computer-implemented method comprising:
storing a validation function and a training set comprising a plurality of training samples;
executing a machine learning (ML) model on the plurality of training samples using a software application during an epoch of a multi-epoch training process performed by the software application, wherein the executing comprises:
retrieving a training sample from the training set;
executing the ML model on the training sample to generate a model prediction for the training sample;
determining an accuracy of the ML model for the training sample based on the model prediction, an expected output, and the validation function;
skipping a back propagation process of the ML model for the training sample based on the accuracy exceeding a pre-determined threshold value; and
retrieving a next training sample from the training set based on the skipping.

2. The computer-implemented method of claim 1, wherein the skipping comprises skipping execution of a loss function on the model prediction of the training sample to compute a loss for the ML model and skipping updating weights of the ML model based on the loss.

3. The computer-implemented method of claim 1, further comprises executing the ML model on a validation set during a previous epoch of the multi-epoch training process to determine the validation function.

4. The computer-implemented method of claim 1, further comprising:
executing the ML model on the next training sample to generate a next model prediction for the next training sample;
determining an additional accuracy of the ML model based on the next model prediction, an expected model output of the next model prediction, and the validation function; and
executing the back propagation process of the ML model for the next training sample based on the additional accuracy not exceeding the pre-determined threshold value.

5. The computer-implemented method of claim 4, further comprising determining the next training sample is a last training sample in the training set, and in response, executing the ML model on a plurality of validation samples in a validation set to generate additional model predictions for the plurality of validation samples, determining a mean validation error of the ML model based on the additional model predictions and expected outputs of the plurality of validation samples, and updating the validation function using the determined mean validation error.

6. The computer-implemented method of claim 1, further comprising determining a similarity value based on a comparison of the training sample and the next training sample, and in response to the similarity value being less than a threshold similarity value, additionally skipping executing of the ML model on the next training sample based on the similarity and retrieving a second next training sample from the training set based on the additionally skipping.

7. The computer-implemented method of claim 1, further comprising presenting a notification on a computer, wherein the notification indicates that the back propagation process is being skipped.

8. A computer system comprising:
a processor set;
a set of one or more computer-readable storage media; and
program instructions, stored in the set of one or more storage media, that cause the processor set to perform computer operations to:
store a validation function and a training set comprising a plurality of training samples;
execute a machine learning (ML) model on the plurality of training samples using a software application during an epoch of a multi-epoch training process performed by the software application, wherein, during the execution of the epoch, the processor set is configured to:
retrieve a training sample from the training set,
execute the ML model on the training sample to generate a model prediction for the training sample,
determine an accuracy of the ML model for the training sample based on the model prediction, an expected output, and the validation function,
skip a back propagation process of the ML model for the training sample based on the accuracy exceeding a pre-determined threshold value, and
retrieve a next training sample from the training set based on the skipping.

9. The computer system of claim 8, wherein the processor set is configured to skip execution of a loss function on the model prediction of the training sample to compute a loss for the ML model and skip a process of updating weights of the ML model based on the loss.

10. The computer system of claim 8, wherein the processor set is configured to execute the ML model on a validation set during a previous epoch of the multi-epoch training process to determine the validation function.

11. The computer system of claim 8, wherein the processor set is configured to:
execute the ML model on the next training sample to generate a next model prediction for the next training sample,
determine an additional accuracy of the ML model based on the next model prediction, an expected model output of the next model prediction, and the validation function, and
execute the back propagation process of the ML model for the next training sample based on the additional accuracy not exceeding the pre-determined threshold value.

12. The computer system of claim 11, wherein the processor set is further configured to determine the next training sample is a last training sample in the training set, and in response, execute the ML model on a plurality of validation samples in a validation set to generate additional model predictions for the plurality of validation samples, determine a mean validation error of the ML model based on the additional model predictions and expected outputs of the plurality of validation samples, and update the validation function using the determined mean validation error.

13. The computer system of claim 8, wherein the processor set is further configured to determine a similarity value based on a comparison of the training sample and the next training sample, and in response to the similarity value being less than a threshold similarity value, additionally skip execution of the ML model on the next training sample based on the similarity, and retrieve a second next training sample from the training set based on the additionally skipping.

14. The computer system of claim 8, wherein the processor set is further configured to present a notification on a computer, wherein the notification indicates that the back propagation process is being skipped.

15. A computer program product comprising:
a set of one or more computer-readable storage media; and
program instructions, stored in the set of one or more computer-readable storage media, for causing a processor set to perform computer operations comprising:
storing a validation function and a training set comprising a plurality of training samples;
executing a machine learning (ML) model on the plurality of training samples using a software application during an epoch of a multi-epoch training process performed by the software application, wherein the executing comprises:
retrieving a training sample from the training set;
executing the ML model on the training sample to generate a model prediction for the training sample;
determining an accuracy of the ML model for the training sample based on the model prediction, an expected output, and the validation function;
skipping a back propagation process of the ML model for the training sample based on the accuracy exceeding a pre-determined threshold value; and
retrieving a next training sample from the training set based on the skipping.

16. The computer program product of claim 15, wherein the skipping comprises skipping execution of a loss function on the model prediction of the training sample to compute a loss for the ML model and skipping updating weights of the ML model based on the loss.

17. The computer program product of claim 15, wherein the processor set is further configured to perform executing the ML model on a validation set during a previous epoch of the multi-epoch training process to determine the validation function.

18. The computer program product of claim 15, wherein the processor set is further configured to perform:
executing the ML model on the next training sample to generate a next model prediction for the next training sample;
determining an additional accuracy of the ML model based on the next model prediction, an expected model output of the next model prediction, and the validation function; and
executing the back propagation process of the ML model for the next training sample based on the additional accuracy not exceeding the pre-determined threshold value.

19. The computer program product of claim 18, wherein the processor set is further configured to perform determining the next training sample is a last training sample in the training set, and in response and executing the ML model on a plurality of validation samples in a validation set to generate additional model predictions for the plurality of validation samples, determining a mean validation error of the ML model based on the additional model predictions and expected outputs of the plurality of validation samples, and updating the validation function using the determined mean validation error.

20. The computer program product of claim 15, wherein the processor set is further configured to perform determining a similarity value based on a comparison of the training sample and the next training sample, and in response to the similarity value being less than a threshold similarity value, additionally skipping executing of the ML model on the next training sample based on the similarity, and retrieving a second next training sample from the training set based on the additionally skipping.
